(19) United States
(12) Patent Application Publication
(10) Pub. No.: US 2018/0044034 A1
(43) Pub. Date: Feb. 15, 2018

(54) Auxiliary Security System for Aircraft Black Box System

(71) Applicant: Astronautics Corporation of America, Milwaukee, WI (US)

(72) Inventors: Bernard Newman, Mequon, WI (US); David Jones, Glendale, WI (US); Ryan Eggert, Waukesha, WI (US); William O'Connor, Cedarburg, WI (US); Stephen DeGuire, Mequon, WI (US)

(21) Appl. No.: 15/556,393

(22) PCT Filed: Mar. 24, 2016
(86) PCT No.: PCT/US2016/023967

§ 371 Date: Sep. 7, 2017

Related U.S. Application Data
(60) Provisional application No. 62/139,118, filed on Mar. 27, 2015.

(51) Int. Cl. B64D 45/00; H04B 7/185; B64D 43/00

(52) U.S. Cl. CPC B64D 45/00; B64D 43/00; H04B 7/1851; B64D 2045/0065; B64D 2045/0075

(57) ABSTRACT

A multifunction avionics server provide for the execution of both certified and uncertified applications in data-serving capacities in which one certified application provides near real-time transmission of flight data recorder type of data. By combining these functions, improved aircraft monitoring is obtained without significant cost or weight penalties.

### CROSS REFERENCE TO RELATED APPLICATION

This application claims the benefit of U.S. provisional application 62/139,118 filed Mar. 27, 2015, and hereby incorporated by reference.

### BACKGROUND OF THE INVENTION

The present invention relates to aircraft electronics (avionics) and in particular to a system for supplementing aircraft voice and data recording systems (black boxes) with real-time monitoring and data transmission.

Most commercial aircraft include one or more “black boxes” such as a Flight Data Recorder (IDR) that records and preserves information from sensors on the aircraft including accelerations, airspeed, altitude, heading, and the like, and a Cockpit Voice Recorder (CVR) that records and preserves the voices of the flight crew and any sounds from the cockpit. These black boxes are constructed to resist damage if the aircraft crashes and may include locator devices such as an ultrasonic beacon to help find the black boxes in the event of submersion. The data preserved in black boxes provides useful information in identifying the cause of the crash and taking action to avoid similar problems in the future.

The physical existence of a black box on an aircraft raises the possibility that it may be damaged during a crash or lost in cases where the aircraft cannot be located. Further, it has recently become apparent that there is a risk of tampering with the black box before, during, and after the aircraft flight.

For this reason, it has been suggested, that the data stored by the black boxes be simultaneously transmitted to a remote location in real-time during the operation of the aircraft, for example, using satellite communication links.

One obstacle to providing such capability is the substantial cost of redesigning and certifying black box hardware for transmission capabilities and the problem of retrofitting a large number of existing aircraft.

### SUMMARY OF THE INVENTION

The present invention provides a system that augments existing, black box hardware to provide parallel, real-time transmission of selected data recorded by the black box to an off board recoding means. Retrofitting costs are minimized by incorporating this capability into existing flight, server and electronic flight bag computer hardware. Flight server and electronic flight bag hardware currently provides an, aviation certified platform for supporting a wide array of general application programs such as flight document viewing and augmented maps and charts. By making use of this existing hardware that can support both general-purpose applications and aviation certified applications, flight data monitoring and transmission may be readily implemented with low marginal cost.

In some embodiments, the invention also provides detection of tampering with the black box system and its associated data feed. This warning can be used by aircraft personnel and/or can trigger external warnings or additional data transmissions. A similar mechanism may be used to monitor critical aircraft functions and to provide for increased transmission of flight data (either in frequency or types of data) when an abnormality is detected.

Specifically, the invention in one embodiment provides an avionics serves for supplementing black box operation by real-time transmission of black box data. The server includes an electronic computer executing a stored program and communicating with an, avionics navigation bus interface and a flight data recorder bus interface adapted to conform to the configuration of the flight data recorder. The server also communicates with a long-range wireless transmitter executing the stored program to: (a) serve flight-related information over the avionics navigation bus to cockpit display devices; and (b) receive data from the flight recorder bus interface and to transmit that data to a receiver remote from the aircraft holding the avionics server using the long-range wireless transmitter.

It is thus a feature of at least one embodiment of the invention to, greatly improve the monitoring and off board transmission, of aircraft data particularly on long oceanic journeys without substantially increasing equipment weight and cost through the execution of monitoring programs as a certified application on a multifunction server that can also serve documents and noncertified display output.

The flight-related information may be fixed presentations of precomposed data selected from the group consisting of electronic pilot manuals, flight checklists, reference documents, equipment lists, and maintenance manuals.

It is thus a feature of at least one embodiment of the invention to provide a server that can perform standard electronic flight bag tasks in addition to augmenting the operation of the flight recorder.

The fixed presentations of precomposed data may be generated by programs executed by at least one, electronic computer and classified as “Type-A” programs as defined by AC 120-76C. Alternatively or m addition, the flight-related information may be dynamically displayed information selected from the group consisting of moving map displays, dynamic weather charts, and merging and spacing displays classified as “Type-B” and “Type-C” programs as defined by AC 120-76C.

It is thus a feature of at least one embodiment of the m′ to provide a server that can simultaneously and safely execute certified and noncertified applications providing multifunction use in addition to executing a certified program for augmenting the flight recorder,

The avionics server may include a cockpit environment data interface receiving at least one of cockpit video and cockpit audio data and wherein the stored program may further execute to process received cockpit environmental data to provide at least one of (i) a transcription of voices and aural warnings in the audio data for storage or transmission; (ii) an extraction of data from the video for storage or transmission.

It is thus a feature of at least one embodiment of the invention to provide important information related to the operation of the aircraft in a form suitable for remote transmission over existing low bandwidth communication networks.

The stored program may further execute to receive an emergency button command from a crew member to increase the frequency and/or types of data transmitted to the remote receiver.

It is thus a feature of at least one embodiment of the invention to implement a “silent alarm” feature for increasing data collection and/or transmission.

The stored program may further detect tampering with the aircraft as indicated by data received over at least one of the avionics navigation buses and the flight data recorder bus.

It is thus a feature of at least one embodiment of the invention to provide advance warning of possible interference with aircraft flight and operation.

The stored program may monitor interruptions of devices normally attached to at least one of the avionics navigation bus and flight data recorder bus to provide at, least one of the transmission of information related to the tampering to the crew and a transmission of information related to the tampering over the long-range wireless transmitter.

It is thus a feature of at least one embodiment of the invention to provide sophisticated bus monitoring to detect intrusions and the like in the data networks on an aircraft.

The detected interruption may be an interruption of communications with the flight data recorder.

It is thus a feature seat least one embodiment of the invention to provide automatic identification of advanced indications of tampering with the flight data recorder to provide valuable information to the crew and or external parties.

The data transmitted to the receiver remote from the aircraft data may include a timestamp and current aircraft position.

It is thus a feature of at least one embodiment of the invention to implement minimal aircraft tracking without substantially increasing the equipment costs and weight on the aircraft.

The program may execute to transmit data to the receiver remote from the aircraft in less than 250 milliseconds after the data is received over one of the avionics navigation bus interface and flight data recorder bus interface.

It is thus a feature of at least one embodiment of the invention to greatly reduce motivation to tamper with the flight data recorder by ensuring contemporaneous retransmission of critical data.

The long-range wireless transmitter may be for example, a SATCOM transceiver, a VHF transceiver, or a HF transceiver.

It is thus a feature of at least one embodiment of the invention to provide a system that can work with existing long-range radio communication infrastructure.

The electronic computer may provide both a certified and noncertified operating system for executing different portions of the stored program.

It is thus a feature of at least one embodiment of the invention to implement a flight data recorder augmenting system as a certified program operable with other certified and noncertified programs on a common server system.

The avionics server may further include a wireless transceiver interface receiving wireless data from a transceiver having a range limited to the aircraft.

It is thus a feature of at least one embodiment of the invention to provide a system that can flexibly communicate with wireless devices in the possession of crew members in and outside of the cockpit for increased security.

The avionics server may further transmit aircraft information from the avionics navigation bus interface.

It is thus a feature of at least one embodiment of the invention to augment the data normally available to the flight data recorder.

These particular objects and advantages may apply to only some embodiments falling within the claims and thus do not define the scope of the invention.

### BRIEF DESCRIPTION OF THE DRAWINGS

FIG. 1 is a simplified, fragmentary, phantom view of an airframe showing various aircraft data buses communicating between cockpit instrumentation and aircraft black boxes and showing an aircraft bay holding an electronic flight bag server used in the present invention

FIG. 2 is a block diagram of the electronic flight bag server of FIG. 1 such as may communicate with multiple of the aircraft buses; and

FIG. 3 is a logical diagram of isolated processing spaces maintained by the electronic flight bag server of FIGS. 1 and 2 for executing certified and uncertified application programs.

### DETAILED DESCRIPTION OF THE PREFERRED EMBODIMENT

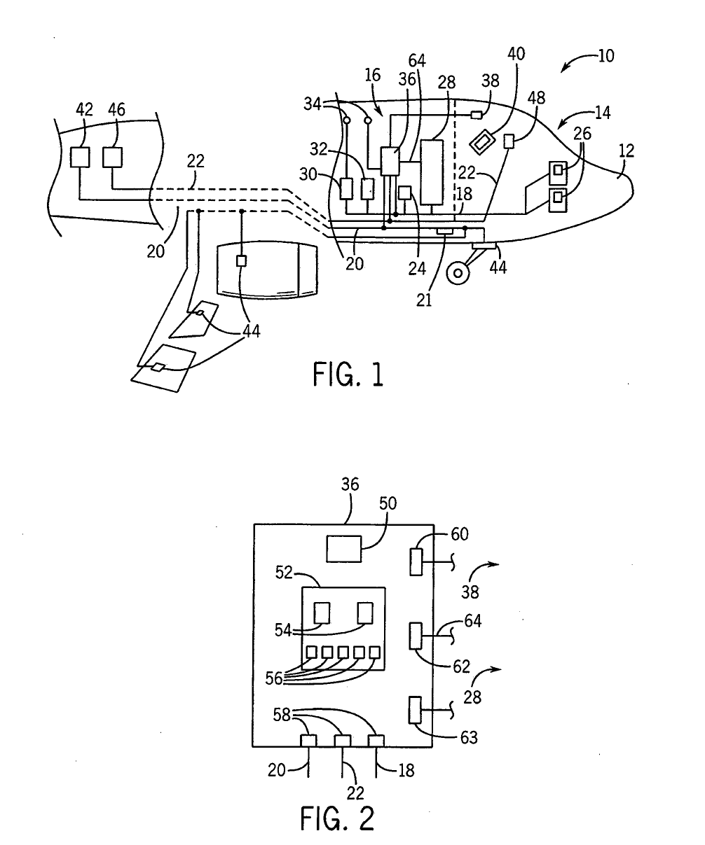

Referring now to FIG. 1, the present invention may be employed in an aircraft 10 having an airframe 12 holding a cockpit 14 and avionics bay 16. Multiple avionics buses may route through the airframe 12 including an avionics navigation bus 18 (ARINC 429/619), a flight data recorder bus 20 (ARINC 717) and an avionics voice bus 22. ARINC standards are prepared and administered by the Airlines Electronic Engineering Committee of the SAE. Industry Technology Consortia having offices in Warrendale, Pa.

As will be discussed in more detail below, the avionics navigation bus 18 carries navigational data, for example, from navigational hardware 24 including one or more of GPS, inertial, and radio-based navigational systems. The avionics navigation bus 18 communicates with one or more flight management system computers 26 such as may hold flight plan data and map information and provide a display of the same to the flight crew. The avionics navigation bus 18 may also communicate with an communication management unit 28 such as an Air Traffic Services Unit (ATSU) or a Communication Management Unit (CMU) that includes certified hardware and software for the processing of avionics navigational data such as may help manage the avionics navigation bus 18 and perform offloaded processing needed for navigation or the like.

The avionics navigation bus 18 may also connect via the communication management unit 28 with a VT-IF transceiver 30 and a SATCOM transceiver 32 which each communicate using respective antennas 34 to provide for data links using either VHF frequencies for line-of-sight transmissions or satellite communications.

The avionics navigation bus 18 may also connect with electronic flight bag server 36 of the present invention which may communicate with a wireless transceiver 38, for example, located in the cockpit 14 for the communication with portable wireless devices 40 such as tablets or the like as well as provide for direct wire connections to similar devices (not shown). The design of an electronic flight bag server 36 for this purpose is described in PCT application PCT/US2015/016816 claiming the benefit of U.S. provisional application 61/942,931 filed Feb. 21 2014, assigned to the assignee of the present invention and hereby incorporated, by reference.

The electronic flight bag server 36 may provide for the execution of both so-called “Type-C” applications that are certified to interact with the aircraft data network over the avionics navigation bus 18 as well as “Type-A” and “Type-B” that are not so certified and typically make use of commercial off-the-shelf (COTS) software. In order to prevent interference with critical aviation functions, such electronic flight bag servers may incorporate features to segregate these two types of applications. An electronic flight bag server 36 suitable for use with the present invention is described in U.S. Pat. No. 9,223,633 issued Dec. 29, 2015, assigned to the assignee of the present invention and hereby incorporated by reference.

In this regard, the electronic flight bag server 36 may provide for communications, for the “Type-A” and “Type-B” but also for the “Type-C” applications, with portable electronic devices such as tablets or the like to provide these convenient and familiar devices to be used to assist the pilot and crew as discussed above.

The flight data recorder bus 20 is connected to a Flight Data. Recorder 42 located in the tail of the airframe 12. The Flight Data. Recorder 42 may be an aircraft “black box” using technology established for preservation of important aircraft information in, the event of aircraft failure or loss. This flight data recorder bus 20 may also communicate via a data concentrator 21 (e.g. a flight data acquisition unit “FDAU” or similar device) with various sensors 44 sensing data including aircraft accelerations., airspeed, altitude, heading, attitudes, cockpit control positions, thermometers, engine gauges, fuel flow, control surface positions, autopilot status, switch positions, landing gear positions, etc. The data is recorded in the memory system of the Flight Data Recorder 42. The electronic flight bag server 36 attaches to the flight data recorder bus 20 downstream from the data concentrator 21.

The avionics voice bus 22 may extend between a cockpit voice recorder 46 and microphones 48 in the cockpit, for example, associated with voice communication systems of the flight crew. The electronic flight bag server 36 attaches to the avionics voice bus 22 to receive data therefrom.

Referring now to FIG. 2, the electronic flight bag server 36 may include one or more processors 50 communicating with a memory system 52, for example, including dynamic random access memory and nonvolatile disk or solid-state storage. The memory system 52 may hold one or more operating systems 54, for, example, a hypervisor or virtualizing operating system and a guest operating system that may be certified (for example, the latter being based on the open-source Linux operating system and the former employing Linux's Kernel-based virtual machine), and a standard, proprietary consumer operating systems such as the Windows operating system manufactured by Microsoft Corporation. In addition, the memory system 52 may hold one or more applications 56 executable on either one of the certified or, standard consumer operating systems. Importantly, the two operating systems may be partitioned on the electronic flight bag server 36 in a way to prevent interference from applications running on the consumer operating system with critical aircraft operations executing, on the certified operating system.

The electronic flight bag server 36 may also provide for multiple interface circuits 58 communicating, respectively, with the avionics navigation bus 18, flight data recorder bus 20, and avionics voice bus 22, as well as a dedicated interface 60 to the wireless transceiver 38 and a high-speed Ethernet interface 62 that may provide for direct communication with communication management unit 28 through Ethernet link 64 as an alternative to or in addition to communication through the avionics navigation bus 18. In addition, the electronic flight hag server 36 may provide a DVI interface 63 for receiving video born cabin Video cameras (not shown).

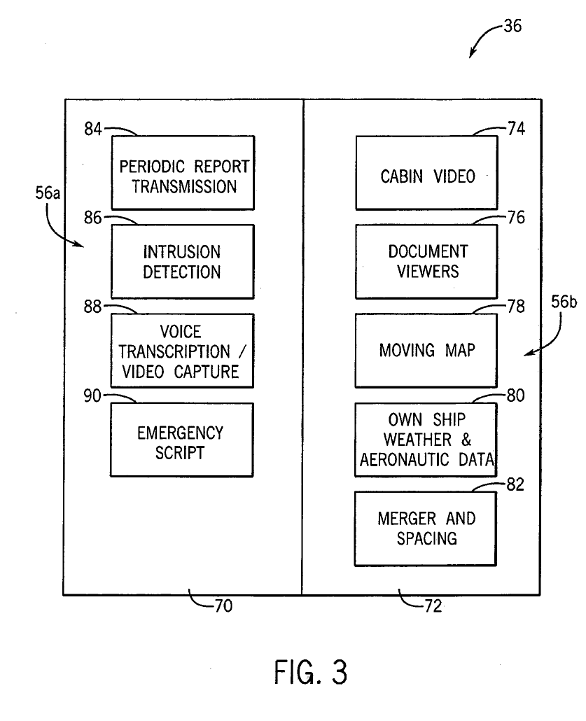

Referring now also to FIG. 3, the processor 50 executing the operating systems 54 may create two partitioned execution spaces 70 and 72 such that the execution space 70 is reserved for flight-critical or certified applications 56a, while execution space 72 is reserved for noncritical, noncertified applications 56b, for example, “Type-A” or “Type-B” applications.

“Type-A” applications include fixed presentations of pre-composed data traditionally presented in paper format (electronic pilot manuals, flight checklists, reference documents, equipment lists, and maintenance manuals), “Type-B” applications include interactive, applications that can manipulate dynamic data and presentation (terminal charts, performance calculations, cabin video).

As a noted above, the electronic flight bag server 36 may execute a number of noncertified applications 56b in execution space 72. These noncertified applications 56b assist in operation of the aircraft including, for example, the display of cabin video for a cabin video application 74 receiving data from the DVI interface 63. Other noncertified applications 56b include document viewing applications 76, for example, for viewing image text files related to flight operation manuals (FOM), terminal charts, checklists and the like. The noncertified applications 56b may also include applications which make use of navigational information obtained from the avionics navigation bus 18 including an airport moving map application 78 which shows a map of the airport with the aircraft located thereon with the map moving as the aircraft moves to maintain correct relative position of the aircraft map, in addition, the noncertified applications 56b may also include an own-ship position, weather, and aeronautical applications 80 showing the location of the aircraft superimposed on sophisticated weather and aeronautical data maps not normally available from the flight management system computers 26. In addition, the noncertified applications 56b may include a merger and spacing application 82 providing areal-time map that helps the aircraft maintain a proper spacing with other aircraft in the area.

The electronic flight bag server 36, using execution space 70, may also concurrently execute a number of certified applications 56a including a black box supplemental application 84 that collects data from the various flight data recorder bus 20, avionics navigation bus 18, and avionics voice bus 22 and periodically transmits that data in compressed form using one of VHF transceiver 30 and SATCOM transceiver 32. Generally this data will be time stamped and will also include current position and status reports. A delay of less than 250 milliseconds from the time of receiving the data at the electronic flight bag server 36 to the VHF transceiver 30 or SATCOM transceiver 32 may be observed and this process of transmission may repeat every 15 minutes. Generally this black box supplemental application 84 may fully duplicate or augment the data that are normally sent by the Flight Data Recorder 42 and/or cockpit voice recorder 46. The direct Ethernet link 64 to the communication management unit 28 facilitates collecting and compressing the necessary data obtained from the communication management unit 28; however, the black box supplemental application 84 may also communicate directly with other subsystems including the navigational hardware 24.

The execution space 70 may also hold certified applications 56a in the form of an intrusion detection application 86 to detect tampering with the aircraft or its systems including the Flight Data Recorder 42 and cockpit voice recorder 46. Generally this intrusion detection application 86 may accomplish the following tasks:

1. crosschecking the data transmitted on the avionics navigation bus 18 and flight data recorder bus 20 for possible inconsistency in the data being reported;

2. checking the physical layer of the avionics navigation bus 18 and flight data recorder bus 20 for abnormalities, for example, including: (a) new devices having new bus, addresses that have been attached to the avionics navigation bus 18 or the flight data recorder bus 20 after commissioning of the electronic flight bag server 36 or at any time after commencement of a flight; (b) different devices having duplicate addresses as detected by Media Access Control (MAC) address or the like; (c) devices that are not observing the bus protocol, for example, failing to relinquish right-of-way to other transmitting devices or using improper protocol headers or footers: (d) devices that arc using abnormal transmission voltages or frequencies on the physical media of the buses; (e) devices that are consuming excess bandwidth on the buses, and (f) bandwidth limits on the buses being exceeded for any reason;

3. checking for the loss on a momentary or permanent basis of devices normally connected to the buses and in particular for an interruption of communication with the flight data recorder. For example, the flight data recorder 42 may transmit a periodic “heartbeat” signal at a regular time interval that may be monitored with respect to timing or a sequence code embedded in the heartbeat signal;

4. comparing the activity on the buses to a fixed or heuristic standard, for example, using machine learning systems or the like trained to normal aircraft operation; thus, for example, data may be stored on a successful flight and uses a training set for a supervised machine learning system. Deviations from standard signals may be used to present information to the crew or an external monitoring device; and

5. checking values of data transmitted on the buses against a rule-based anomaly detector detecting abnormal or unusual aircraft operation or activity against predefined rules. These predefined rules may be developed by monitoring data collected during uneventful flights to establish rules and ranges.

This intrusion detection application 86 may, upon detecting an anomaly or intrusion, transmit this fact as part of the transmissions of the black box supplemental application 84, increase the transmission rate of the black box supplemental application 84, and provide a notification to the flight crew of the same, for example, through the wireless device 40 or wired devices. In addition, this data may be enrolled in the flight data recorder itself.

The execution space 70 may further hold a certified application 56a in the form of a cockpit environment monitoring program 88 providing voice-to-text transcription for recording the cockpit voice signals. Voice-to-text transcription may make use of currently available speech recognition programs to provide a highly compressed version of cockpit voice signals that may be relayed effectively over low data capacity links. In addition or alternatively, the cockpit environment monitoring program 88 may extract snapshots from a video stream that can be effectively compressed and transmitted. Face recognition software may be used to isolate and transmit face images.

The execution space 70 may further hold a certified application 56 a in the form of an emergency script 90, for example, activated when an emergency button implemented, for example, on one of the wireless devices 40 is pressed by flight crew. The emergency script, for example, may increase the amount of data stored on the electronic flight bag or flight server and transmit it remotely using the present invention. In addition, emergency transmissions may be activated through rule-based criteria, increasing the amount of data stored in the electronic flight bag or flight server for remote transmission using the present invention.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference, which is made clear by reference to the text and the associated drawings describing the component under discussion. Such terminology may include the words specifically mentioned above, derivatives thereof, and words of similar import.

Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

AR INC 429, 619 and ARINC 717 standards are hereby incorporated by reference.

What we claim is:

1. An avionics server for supplementing black box operation by real-time transmission of black box data comprising:
at least one electronic computer executing a stored program;
an avionics navigation bus interface communicating with the electronic computer;
a flight data recorder bus interface communicating with the electronic computer and adapted to communicate with a flight data recorder; and
a long-range wireless transmitter;
wherein the stored program executes to:
(a) serve flight-related information over the avionics navigation bus to cockpit display devices; and
(b) receive data from the flight recorder bus interface and transmit that data to a receiver remote from an aircraft holding the avionics server using the long-range wireless transmitter.

2. The avionics server of claim 1 wherein flight-related information is in fixed presentations of precomposed data selected from the group consisting of: electronic pilot manuals, flight checklists, reference documents, equipment lists, and maintenance manuals.

3. The avionics server of claim 2 wherein the fixed presentations of precomposed data are generated by programs executed by the at least one electronic computer and classified as Type-A programs.

4. The avionics server of claim 1 wherein flight-related information is dynamic display information selected from the group consisting of: moving map displays, dynamic weather charts, and merging and spacing displays.

5. The avionics server of claim 4 wherein the dynamic display information is generated by programs executed by the at least one electronic computer and classified as Type-B programs.

6. The avionics server of claim 1 further including a cockpit environment data interface receiving at least one of cockpit video and cockpit audio data and wherein the stored program further executes to process received cockpit environmental data to provide at least one of a (i) transcription of at least one of voices and aural warnings in the audio data for storage or transmission; and (ii) are extraction of data from the video for storage or transmission.

7. The avionics server of claim 4 wherein the stored program farther executes to receive an emergency button command from a crew member to increase at least one of frequency and type of the data transmitted to the remote receiver.

8. The avionics server of claim 1 wherein the stored program further executes to detect tampering, with the aircraft as indicated by data received over at least one of the avionics navigation bus and the flight data recorder bus.

9. The avionics server of claim 8 wherein the detection of tampering monitors interruptions of devices normally attached to at least one of the avionics navigation bus and flight data recorder bus to provide at least one of the transmission of information related to the tampering to a crew of the aircraft and/or a transmission of information related to the tampering over the long-range wireless transmitter.

10. The avionics server of claim 1 wherein the interruption is an interruption of communications with the flight data recorder.

11. The avionics server of claim 1 wherein the data transmitted to the receiver remote from the aircraft data includes a timestamp and current aircraft position.

12. The avionics server of claim 1 wherein the program executes to transmit data to the receiver remote from the aircraft in less than 250 milliseconds after the data is received over one of the avionics navigation bus interface and flight data recorder bus interface.

13. The avionics server of claim 1 wherein the long-range wireless transmitter is selected from a SATCOM transceiver, a VHF transceiver, and a HF transceiver.

14. The avionics server of claim 1 wherein the electronic computer provides both a certified and noncertified operating system for executing different portions of the stored program.

15. The avionics server of claim 1 further including a wireless transceiver interface receiving wireless data from a transceiver having a range limited to the aircraft.

16. The avionics server of claim 1 wherein (b) further transmits aircraft information from the avionics navigation bus interface.

17. The avionics server of claim 1 wherein the avionics navigation bus interface conforms to ARINC 717, 429, or Ethernet.

18. The avionics server of claim 1 wherein the flight data recorder bus interface conforms to ARINC 717, ARINC 767 or Ethernet.

19. The avionics server of claim 1 wherein the stored program further executes to analyze data received over at least one of the avionics navigation bus and the flight data recorder bus against rules detecting abnormal or unusual, aircraft operation or activity to increase data transmitted using the ling-range wireless transmitter.
